(19) United States
(12) Patent Application Publication
(10) Pub. No.: US 2024/0300406 A1
(43) Pub. Date: Sep. 12, 2024

(54) MULTI-COLOR COMBINATION LIGHTING DEVICE FOR VEHICLES INCLUDING SCHOOL BUSES

(71) Applicant: William Alan Wakefield, Plymouth, MI (US)

(72) Inventor: William Alan Wakefield, Plymouth, MI (US)

(21) Appl. No.: 18/597,911

(22) Filed: Mar. 6, 2024

Related U.S. Application Data
(60) Provisional application No. 63/451,079, filed on Mar. 9, 2023.

(51) Int. Cl. B60Q 1/26; B60Q 1/34; B60Q 1/44; B60Q 1/46; F21S 43/14; F21V 3/04; F21W 103/20; F21W 103/35; F21W 103/45; F21W 107/10; F21Y 105/16; F21Y 113/17; F21Y 115/10

(52) U.S. Cl. CPC B60Q 1/2696; B60Q 1/34; B60Q 1/44; B60Q 1/46; F21S 43/14; F21V 3/049; B60Q 2400/20; B60Q 2800/30; F21W 2103/20; F21W 2103/35; F21W 2103/45; F21W 2107/10; F21Y 2105/16; F21Y 2113/17; F21Y 2115/10

(57) ABSTRACT

According to some embodiments, a unitary lighting device is disclosed. The unitary lighting device includes a housing that comprises a clear lens area and a printed circuit board assembly. The printed circuit board assembly is disposed within the housing, and includes light emitting diodes (LEDs) that are configured for outputting multiple different colors.

### BACKGROUND

There are many known lighting devices for vehicles which emit light in various colors for various purposes, e.g., amber colored turning indicators, white colored back up indicators, red colored running lights and brake indicators, etc. Known vehicular lighting devices employ various light sources, including incandescent bulbs, halogen bulbs, and LED's, although LEDs are predominantly the light source used in most vehicular lighting devices today, and any of the various light sources may be used in conjunction with clear or tinted/colored lenses to produce various colored light outputs to indicate the status of a vehicle's operations. Such status includes but is not limited to being “in park,” “in reverse,” “stopping,” or signaling an intended turn. Such vehicular lighting devices may be integrated into the body of a vehicle or be permanently or temporarily attached to the body of a vehicle through various means including simple fasteners such as screws and bolts or suction cups or magnets (as one might see on a vehicle in tow). In relation to warning and signal lights for school busses these may, for example, indicate the pending stop of a school bus for loading or unloading of passengers, braking, turning, and the like, the warnings and signals being necessary for the safety of passengers, motorists, and passersby and are generally regulated by law.

Historically, school bus Warning Lights and Signal Lights consist exclusively of separate lighting fixtures for each of the amber Warning Lights, red Warning Lights, amber Turn Signal Lights, and red Stop/Tail Lights. The need for separate lighting fixtures was driven by the requirements for minimum illumination area of each light as defined by FMVSS 108 and the National School Transportation Specifications and Procedures as published by the National Congress on School Transportation (NCST) as well as the space limitations posed by the design of the front and rear mounting surfaces on school buses. Effectively, the minimum area of illumination required by regulation and the maximum mounting area available for the Warning and Signal Lighting are so close to one another that they drove the lighting industry to establish norms for school bus lighting to use 7-inch diameter round lights and/or 5-inch by 8-inch rectangular lights to achieve the desired lighting requirements that fit the available mounting area.

Typically, there may be eight (8) warning lights on a school bus cap area (four (4) in front and four (4) in back) and six (6) or more signal and/or warning lights on the rear of a school bus usually on its midsection. Each fixture results in a penetration of the school bus sheet metal body for mounting and/or electrical connections. Such penetrations are of particular concern for warranties of school buses. Through such penetrations water incursion may occur creating corrosion and erosion. Further, each fixture also requires pig-tail wiring or another connecting device, which creates added complexity to the school buses wire harness. Each individual device thus requires grommets and/or a sealant to prevent water intrusion-leading to complexity in installation and maintenance, and hence substantial cost.

FIGS. 1 and 2 are images depicting front and rear ends of a school bus employing conventional warning and signal lights. In FIG. 1, there are shown amber warning lights 1, red warning lights 2, red or amber side signal lights 3, red or amber turn signal lights 4, red park/stop signal lights 5, and a stop arm 6 with red stop lights. All of these are conventional lights provided at the front portion of a school bus. The rear portion of the school bus as illustrated in FIG. 2 may contain amber warning lights 31, red warning lights 32, white or clear back up lights 33, amber turn signal lights 34, and red brake lights 35.

FIG. 3(a) is an exploded view of a conventional lighting device for school busses, which may be used as a turn signal light, a stop/brake light, a running light, a reverse light, etc., while FIG. 3(b) shows the conventional lighting device as assembled. As shown, the conventional lighting device may include an outer lens 10, self tapping screws 11, an inner lens 12, a printed circuit board assembly (PCBA) 13 having LEDs, a PCBA support 14, a housing 15, and a gasket 16 which seals around the holes that penetrate through the surface of the school bus to receive the wiring of the lighting device. To impart desired color to the light outputted by the lighting device, the outer lens 10 and/or the inner lens may be tinted to have the desired color and/or the LEDs may emit light in the desired color.

While the known vehicular lighting devices are suitable for their intended functions and have been used for many years, they still remain to be improved upon in terms of size, illumination output, flexibility and convenience in use, cost, and overall efficiency. For example, even though many of the known lighting devices used on school buses are sufficiently large to meet federal and local governmental requirements, greater visibility of the signals output by the lighting devices is generally desirable, but it is not practical to simply increase the size of existing vehicular lighting devices to give the greater illumination and visibility because there are other important considerations regarding this, including overall size limits of parts of the school busses to which the lighting devices are affixed, cost and appearance. Further, use of the known lighting devices requires many different light devices to fulfill all of the many governmental requirements of school bus signal and warning lights, and thus a corresponding number of penetrations into the bus's sheet metal hull are also required and thus present issues in installation efficiency and the potential for water intrusion.

Hence, there remains room for improvement and a need in the art for an improved lighting device for vehicles that can overcome the limitations of the presently known devices, and can further decrease costs associated with the known lighting devices, including those used on school buses.

### SUMMARY

According to some embodiments, a unitary lighting device is disclosed. The unitary lighting device includes a housing that comprises a clear lens area and a printed circuit board assembly. The printed circuit board assembly is disposed within the housing, and includes light emitting diodes (LEDs) that are configured for outputting multiple different colors.

### BRIEF DESCRIPTION OF THE DRAWINGS

FIG. 1 depicts a front of a school bus employing conventional warning and signal lights.

FIG. 2 depicts a rear of a school bus employing conventional warning and signal lights.

FIG. 3 is an exploded view of a conventional lighting device for school busses.

FIG. 3, illustrates a school bus lighting device according to some embodiments.

FIG. 5 depicts an exploded view of a conventional lighting device for school busses.

FIG. 6 illustrates a school bus lighting device according to some embodiments.

### DETAILED DESCRIPTION

The present embodiments may provide an improved lighting device which satisfies the above discussed need. The present embodiments relate to an improved warning lighting device for vehicles, including school buses, which provide enhanced visibility to motorists and others in the vicinity of the vehicles, regarding the vehicles' operations, and wherein the improved lighting device has a comparable size to conventional vehicle warning and signal lights, but with a more visible light output, a simpler structure, and lower costs. More particularly, the present embodiments relate to an improved vehicle lighting device which may satisfy existing regulations for vehicle lights, but which may also be configured to selectively provide multiple different warnings and indications by a single lighting device which may be selectively controllable to emit various colors of light corresponding to different warnings or signals, and which may provide increased light output and visibility for increased safety, while creating efficiencies for production and lower costs to manufacturers and purchasers of the vehicles.

The present embodiments may related to a unitary lighting device for school busses which may be configured to selectively output light rays in multiple different colors and/or color combinations, wherein the light rays in multiple different colors and/or color combinations respectively correspond different warning signals, wherein the unitary lighting device includes LEDs and at least one lens which output the light rays in multiple different colors and/or color combinations, and wherein the unitary lighting device may be configured to be mounted to a surface of a school bus. Such unitary lighting device may be configured to be selectively receive power from a remote power source provided on the school bus for outputting the light rays in multiple different colors and/or color combinations. Also, because such unitary lighting device may be configured to selectively output the light rays in multiple different colors and/or color combinations, the single unitary lighting device may be used to replace multiple conventional lighting devices which each only output light rays in a single color. Correspondingly, this permits the unitary lighting device to comprise an increased size and increased light output in comparison to each of the conventional lighting devices it replaces, e.g., it may encompass the area of the two conventional lighting devices it replaces as well as the area in between the replaced, conventional lighting devices, while still satisfying the size limits available for lighting devices on the various surfaces of the school busses. When such a unitary lighting device having increased size is operated, the entire lens area and light output of the increased size device may be much larger than those of the individual, conventional lighting devices, and may correspondingly be more visible to motorists and others in the vicinity of the vehicles on which the unitary lighting device is provided, including school buses. The increase in size and light output for a given light color emitted increases visibility and safety and advantageously uses the very limited space on the outer shell of the bus available for lighting devices.

As one exemplary embodiment, the unitary lighting device may include a clear lens and a PCBA that contains either two (2) or more different colored LED's or an LED which can produce the two or more different colors, wherein the different color light rays output by the LEDs correspond to the two or more different colors of the conventional lighting devices the unitary lighting device replaces. The LEDs may be selectively powered to produce the different colors of light output depending on electrical signals received from the school bus' power source, which may be connected to the unitary lighting device through a wire harness or other appropriate means. The clear lens may include reflective optics and may have optical features required to produce light distribution that meet all governmental regulations and specifications. The unitary lighting device may also illuminate only select portions of the clear lens area with any given color light.

In some embodiments, the unitary lighting device may be configured to output dual red/amber color lights, as well as any other additional colors required or recommended by law or statute. Further, the unitary lighting device may come in various sizes and shapes besides the larger, rectangular, and square shaped lighting devices 41-43 shown in the embodiment of FIG. 4, e.g., the lighting devices may be oval, trapezoidal, or any other size and shape that can be accommodated by the current mounting area and produces sufficient illumination to meet governmental regulations and specifications.

In another exemplary embodiment, the unitary lighting device may be operatively associated with a circuit or controller which programmed or otherwise configured to provide appropriate signals so that the lighting device outputs the proper color(s) required for any given situation. The controller may obtain the requisite color directives from various provided on the school bus or other vehicle on which the lighting device is provided, including sensors associated the vehicle's brake pedal, turn signal toggle, running lights, student boarding and exiting devices, etc., as well as from cameras and other imaging devices which monitor around the vehicle.

Another exemplary embodiment of a lighting device may be a single fixture that spans the entire front or rear cap of the bus and outputs multiple different colors to provide various signals and warnings, and include other safety features, including the words “School Bus” in a retro-reflective decal, etc.

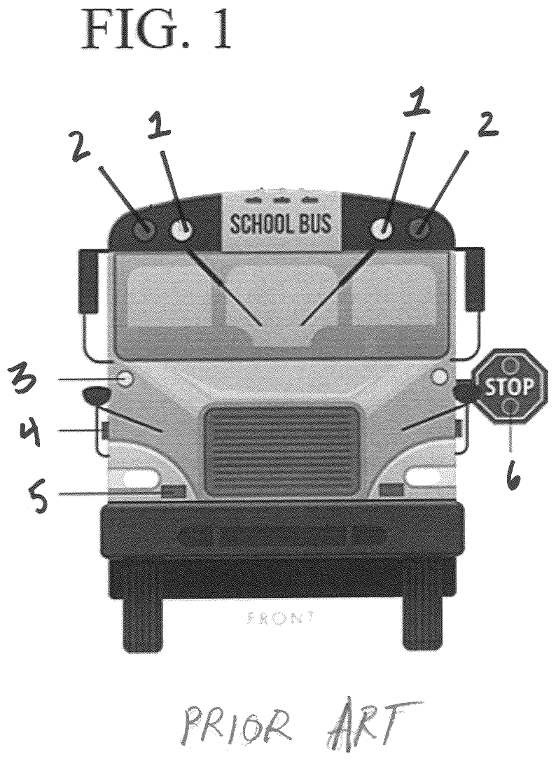

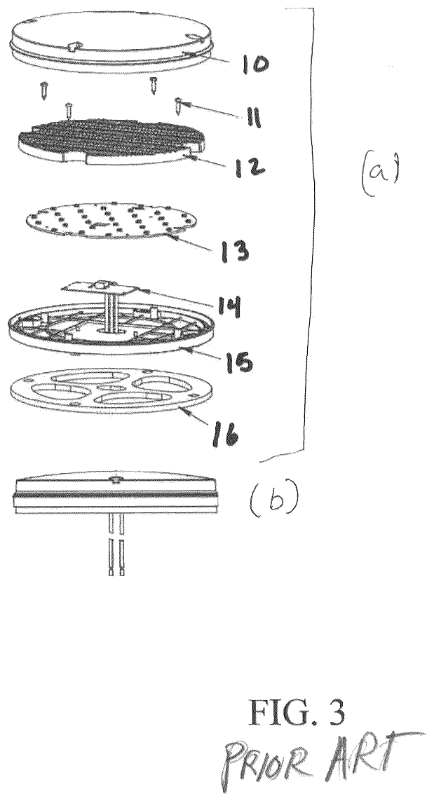

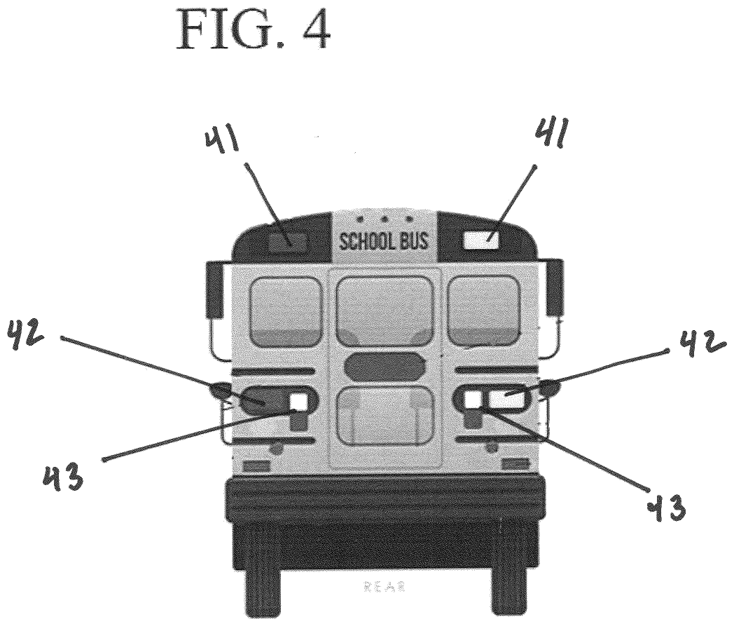

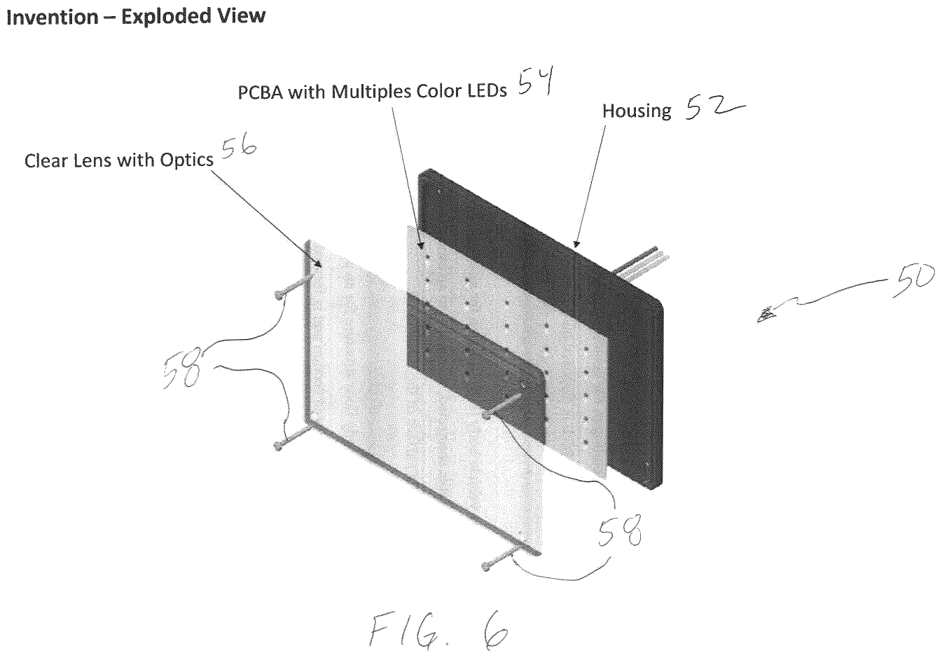

FIG. 4 is a rear image of a school bus having lighting devices 41-43 according to exemplary embodiments provided on rear surfaces of the bus, and such as may be used to replace conventional lighting devices that have been provided on school busses such as shown in FIGS. 1-3(b). FIG. 6 is an exploded view of an exemplary embodiment of a unitary lighting device which has a generally rectangular shape, and which may correspond to the lighting devices 41, 42 in FIG. 4.

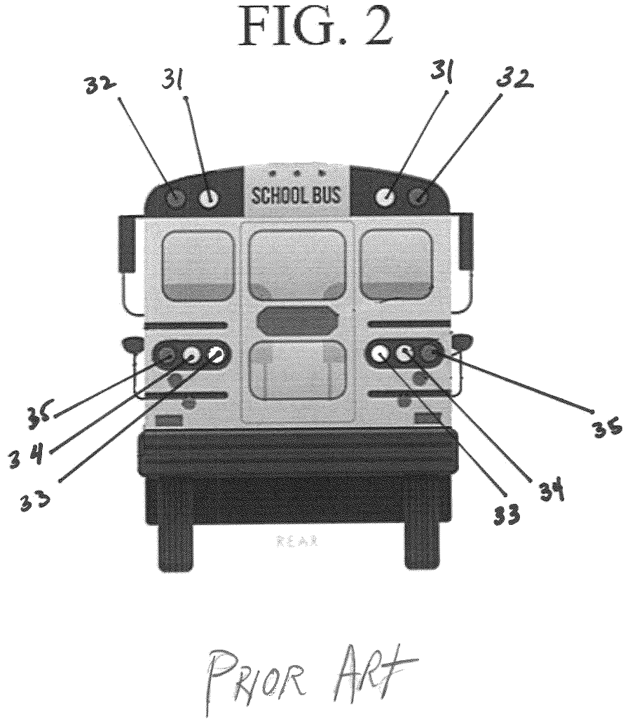

With reference to present FIG. 4, there is shown the rear end of a school bus having three different lighting devices 41-43. Such unitary lighting devices may, for example, be controlled selectively output amber colored light rays or red colored light rays. Such colors are normally associated with the conventional red and amber warning lights 1, 2 which are found as four or more separate lights on the front school bus cap and as four or more separate lights 31, 32 on the top of the rear of a school bus, such as shown in FIGS. 1-2. However, with the unitary lighting device according to the disclosed embodiments, any one of the unitary lighting devices 41-43 can be selectively controlled to output either red color light rays or amber color light rays, so that such unitary lighting device may replace one conventional red warning light 1 and one conventional amber warning light 2. As may be recognized from FIG. 4, the function of eight (8) individual conventional warning lights 1, 2 can be provided using half as many, namely, four (4), of the unitary lighting device according to the present embodiments.

Red and amber signal lights are also generally provided in the rear “belt” of the school bus, about halfway up the sheet metal hull, including the red warning lights 32, the white or clear back up lights 33, the amber turn signal lights 34, and the red brake lights 35 such as shown in FIG. 2. The amber turn signal lights 34 are provided on the right and left sides of the bus' rear surface and are selectively operated to indicate a direction in which the bus turn signal is used, e.g., an amber light needs to be emitted on the right or left, depending on the desired turn direction, and a red light must be emitted on both sides when the school busses brake is employed. Further, white or clear back up lights 33 are also typically provided on the bus' rear belt adjacent to the amber turn signal lights 34. Again, the unitary lighting device, may be used to replace two or more of the conventional lights 32-34 on each side of the bus' rear belt.

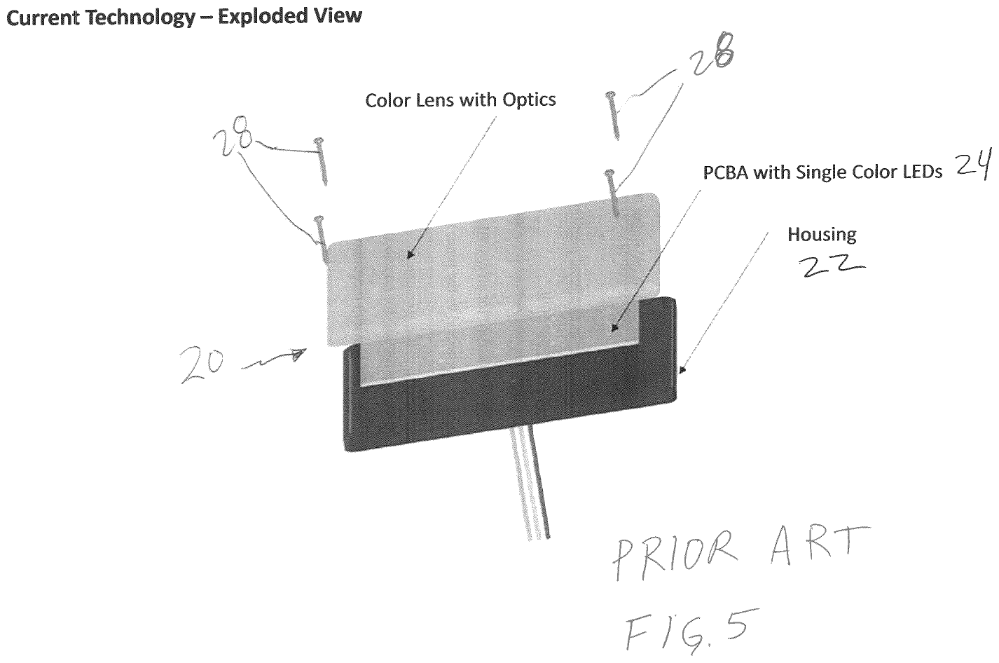

FIG. 4 illustrates two sets of three different unitary lighting devices 41, 42, 43, with one set of the unitary lighting devices provided on each side of the bus' rear end. These six unitary lighting devices may be used to replace ten (10) or more of the conventional lighting devices 31-35 shown in FIG. 2. As shown, each of the unitary lighting devices 41-43 has a generally rectangular shape as has been sometimes conventional employed on a typical school bus, e.g., see the conventional lighting device shown in present FIG. 5. However, in some embodiments a single unitary lighting device may be used for both amber and red warning lamps such as the device 41, a single unitary lighting device may be used for both functions of brake and indicator lights such as the device 42, a single unitary lighting device may be used for both functions of reverse and tail lights such as the device 43.

Referring to present FIG. 5, there is shown an exploded view of another conventional lighting device 20 having a generally rectangular shape typically used for school busses. This conventional lighting device includes a housing 22, a PCBA 24 with LEDS all of a single color, e.g., white, and a lens 26 which is colored, e.g., red or amber, and may be provided with optical features or optics that diffuse and/or direct the light emitted through the lens. The components 22, 24, 26 may be joined together using fasteners 28. The conventional lighting device may be electrically connected to a power source on a bus using wires extending from the lighting device as shown.

Referring to present FIG. 6, there is shown an exploded view of an exemplary embodiment of a unitary lighting device 50 which has a generally rectangular shape typically used for school busses, and which may correspond to the lighting devices 41, 42 in FIG. 4. This unitary lighting device 50 includes a housing 52, a PCBA 54 with LEDS configured to output multiple different colors, e.g., some LEDS which output red light, some LEDS which output amber light and/or some LEDS which selectively output red light or amber light, and a lens 26 which is clear or transparent and may be provided with optical features or optics that diffuse and/or direct the light emitted through the lens. The components 52, 54, 56 may be joined together using fasteners 58. The unitary lighting device 50 may be electrically connected to a power source on a bus using wires extending from the lighting device as shown.

The advantages of the embodiments described herein are numerous. Where previously each individual light fixture was required to have a penetration into a school buses sheet metal hull, now there can be half as many or fewer penetrations as the lighting device according to the exemplary embodiments can provide all necessary warnings and other signals with far fewer electrical connections to the power supply of a given school bus or other vehicle, and any necessary wiring harness may also have a simplified structure in comparison to conventional wiring harnesses for school busses and other vehicles. This directly results in fewer issues of water intrusion and corrosion based on the reduced number of penetrations through which water intrusion conventionally occurs. Each intrusion point typically requires grommets and/or gaskets/and or another acceptable sealant or method of sealing the intrusion point, so that less cost will be incurred for sealing the reduced number of penetrations. Water intrusion points are of great concern for school bus manufacturers and those who would warranty a school bus.

Another advantage is the ability of the unitary lighting device is to better utilize available surface area on a school bus or other vehicle that cannot be expanded as a practical matter by outputting warnings and signals with increased candlepower from the same available surface area. The unitary lighting device described herein is able to provide the increased candlepower output by utilizing the space of two of the conventional lighting fixtures as well as the area that was previously used to provide a separation space between the conventional lighting devices. A large portion of that now utilized space was unused “dead” space that is taken advantage and employed as surface area for the light source by the lighting device. Each individual colored light previously constricted to the space of its own fixture is at least doubled by this, providing a larger surface area for illumination and thus greater illumination. This greater illumination results in better visibility and safety for occupants of the school bus, as well as for motorists around the bus, and pedestrians or bikers in the vicinity of the school bus. It is well known by those of ordinary skill in the art that greater visibility is tantamount to greater safety.

Because an amount of fixtures can be reduced by half or more, the associated electrical wiring, including wire harnesses, of a school bus is simplified. The design and cost of mating the lighting devices according to the present embodiments with the wiring harnesses is simplified. One set of wires may now do the job of two or more sets when using conventional lighting devices. Assembly, component, manufacturing, and warranty costs are all reduced, providing economic efficiencies for the lifetime of the school bus.

While the exemplary embodiments have been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for applications of the lighting devices according to embodiments described herein.

What is claimed:

1. A unitary lighting device comprising:
a housing that includes a clear lens area; and
a printed circuit board assembly, disposed within the housing, and includes light emitting diodes (LEDs) configured for outputting multiple different colors.

2. The unitary lighting device of claim 1, wherein at least one of the LEDs is configured for outputting red light and one of the LEDs is configured for outputting amber light.

3. The unitary lighting device of claim 1, wherein at least one of the LEDs is configured for outputting red light and one of the LEDs is configured for outputting white light.

4. The unitary lighting device of claim 1, wherein at least one of the LEDs is configured for outputting amber light and one of the LEDs is configured for outputting white light.

5. The unitary lighting device of claim 1, wherein at least one of the LEDs is configured for outputting red light, one of the LEDs is configured for outputting amber light and one of the LEDs is configured for outputting white light.

6. The unitary lighting device of claim 1, wherein the clear lens area is transparent and includes optical features for diffusing light emitted through the clear lens area.

7. The unitary lighting device of claim 1, wherein the clear lens area is transparent and does not include optical features for diffusing light.

8. The unitary lighting device of claim 1, wherein select portions of the clear lens area are illuminated with one of the multiple different colors.

9. The unitary lighting device of claim 1, wherein the housing is configured for a school bus.

10. The unitary lighting device of claim 1, wherein the printed circuit board comprises a controller configured to provide appropriate signals to output the multiple different colors required for a given situation based on sensors associated with a brake pedal, a turn signal toggle, and a student boarding.

11. The unitary lighting device of claim 10, wherein signals are further based on cameras.

12. The unitary lighting device of claim 10, wherein signals are further based on a signal that a vehicle will be in reverse.
